(19) United States
(12) Patent Application Publication
(10) Pub. No.: US 2024/0191536 A1
(43) Pub. Date: Jun. 13, 2024

(54) UMBRELLA AND PRIVACY SHIELD FOR AN AUTOMOBILE

(71) Applicant: Richard W. Rasanen, Montesano, WA (US)

(72) Inventor: Richard W. Rasanen, Montesano, WA (US)

(21) Appl. No.: 18/533,068

(22) Filed: Dec. 7, 2023

Related U.S. Application Data
(60) Provisional application No. 63/430,689, filed on Dec. 7, 2022.

(51) Int. Cl. A45B 15/00; A45B 11/00

(52) U.S. Cl. CPC A45B 15/00; A45B 11/00; A45B 2200/1072; A45B 2200/1081

(57) ABSTRACT

An umbrella and privacy shield for use with an automobile having a side door includes an umbrella canopy coupled to a linkage configured to move the umbrella canopy between collapsed and deployed configurations. The umbrella canopy may be temporarily secured to a top or side door of the automobile via a plurality of magnets positioned on the linkage adjacent a peripheral edge thereof. A translucent or opaque curtain may be coupled and hung from a peripheral edge of the umbrella canopy so as to form an interior space that is private and not visible to persons outside the curtain.

### REFERENCE TO RELATED APPLICATIONS

This application is a non-provisional application that claims the priority of provisional patent application 63/430,689 filed Dec. 7, 2022 titled Umbrella and Privacy Shield for an Automobile, which is related to application Ser. No. 17/568,005, filed Jan. 4, 2022, titled Privacy And Weather Shield, now issued as U.S. Pat. No. 11,459,788, all of which are incorporated in their entireties herein.

### BACKGROUND OF THE INVENTION

This invention relates generally to umbrellas and clothing changing assemblies and, more particularly, to a privacy and weather shield that provides portable privacy to a user who needs to change clothes in an otherwise outdoor public environment and provides privacy from both a horizontal position and from an elevated position. Protection is also provided from a weather event such as rain.

Youth sports leagues and teams have become very important to families with children or grandchildren. Commonly, practices and games may be held at remote locations and immediately after school, church, dance practice, or the like. Many sporting events locations, whether a soccer field, a baseball or softball field, or even basketball complex may not have sufficient facilities to change clothing or sports gear. Instead, child athletes often have to change from street clothing to athletic wear or team uniform inside their own or their parent's automobile. In order to stand up, such as to insert one's legs into a pair of pants, one or both side doors of the automobile may be opened for convenience as well as for a limited amount of privacy.

Various devices have been proposed in the prior art for providing a level of privacy to a person changing clothing adjacent an open door of a vehicle. Although presumably effective for their intended purposes, the existing devices are still insufficient to provide privacy from an elevated position, such as from a person standing on a hill, on bleachers, from an elevated truck bed, or the like. Further, existing privacy assemblies do not shield a user from weather events such as rain or snow. It would especially be desirable to have a canopy in place when putting a car carrier and baby inside the automobile when it is raining. Therefore, it would be desirable to have a privacy and weather shield having a canopy that provides privacy from an elevated viewpoint. Further, it would be desirable to have a privacy and weather shield having a canopy that may be positioned in a tight configuration atop a cabin and open door of an automobile. In addition, it would be desirable to have a privacy and weather shield that is portable and includes curtains that may be quickly and easily coupled to respective peripheral edges of the canopy. Still further, it would be desirable to have a privacy and weather shield having a canopy that may be coupled to the automobile door for stability when deployed.

### SUMMARY OF THE INVENTION

Therefore, a general object of this invention is to provide an umbrella and privacy shield that provides a private area for a person in the vicinity of an automobile to change clothing without being viewed by other people.

Another object of this invention is to provide an umbrella and privacy shield, as aforesaid, that not only surrounds a person at ground level but includes a canopy for preventing view from an elevated geographic position.

Yet another object of this invention is to provide an umbrella and privacy shield, as aforesaid, that may be magnetically secured to a rooftop of a vehicle and that provides a canopy that shields from a rain event.

Still another object of this invention is to provide an umbrella and privacy shield, as aforesaid, that is portable, i.e., that may be assembled and disassembled quickly and easily.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of an umbrella and privacy shield according to a preferred embodiment of the present invention, illustrated in a fully deployed configuration;

FIG. 1b is a perspective view of the umbrella and privacy shield as in FIG. 1, illustrated with the curtain removed;

FIG. 2 is an elevated rear perspective view of the umbrella and privacy shield as in FIG. 1b;

FIG. 3a is a perspective view of the umbrella and privacy shield according to the present invention, illustrated removed from the automobile;

FIG. 3b is an exploded view of the umbrella and privacy shield as in FIG. 3a;

FIG. 4a is a perspective view of the privacy curtain in a folded or retracted configuration;

FIG. 4b is a top view of the privacy curtain as in FIG. 4a;

FIG. 5a is a perspective view of the umbrella according to the present invention, illustrated in a fully deployed figuration; and

FIG. 5b is an isolated view on an enlarged scale taken from FIG. 5a.

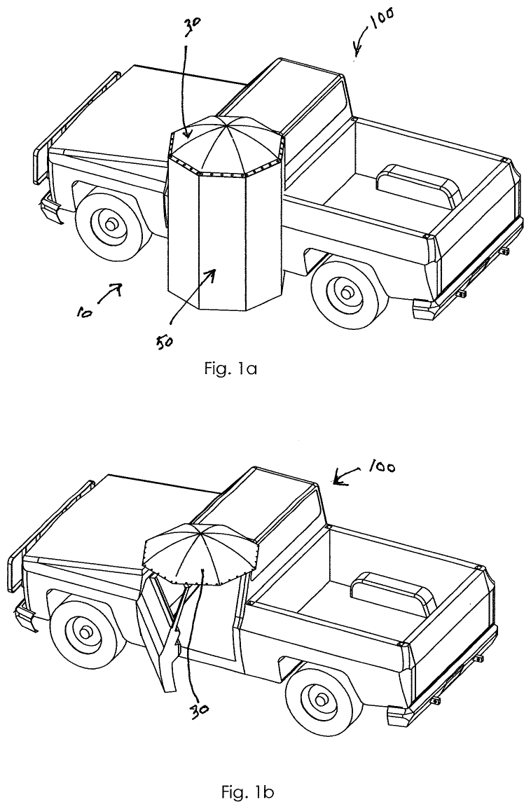

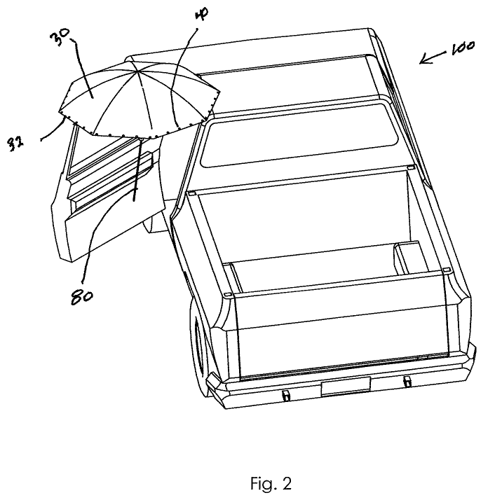

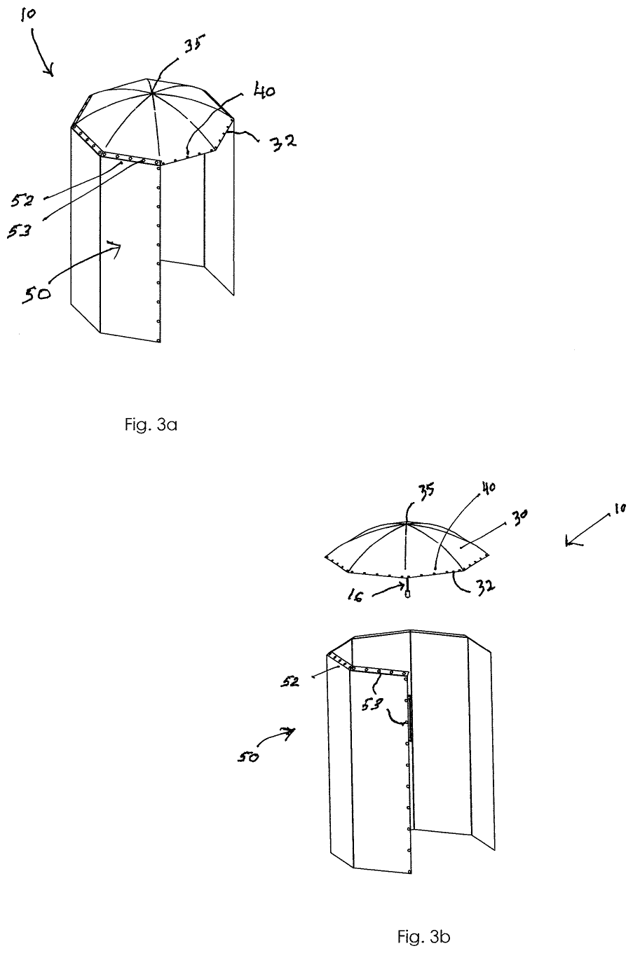

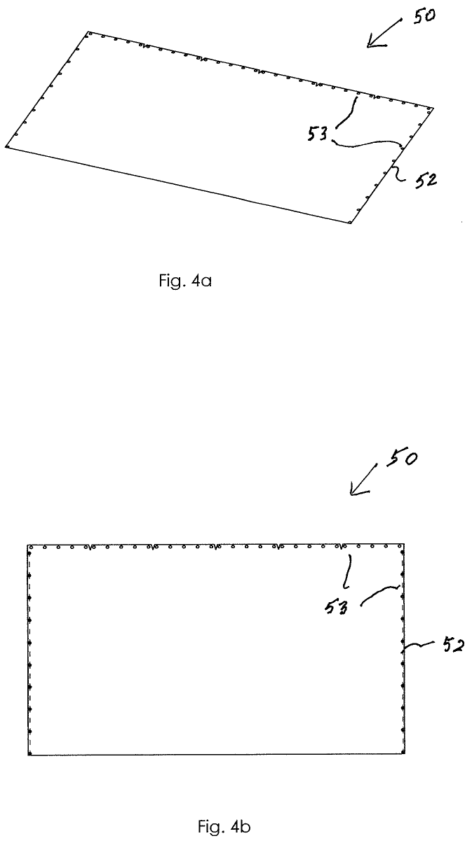

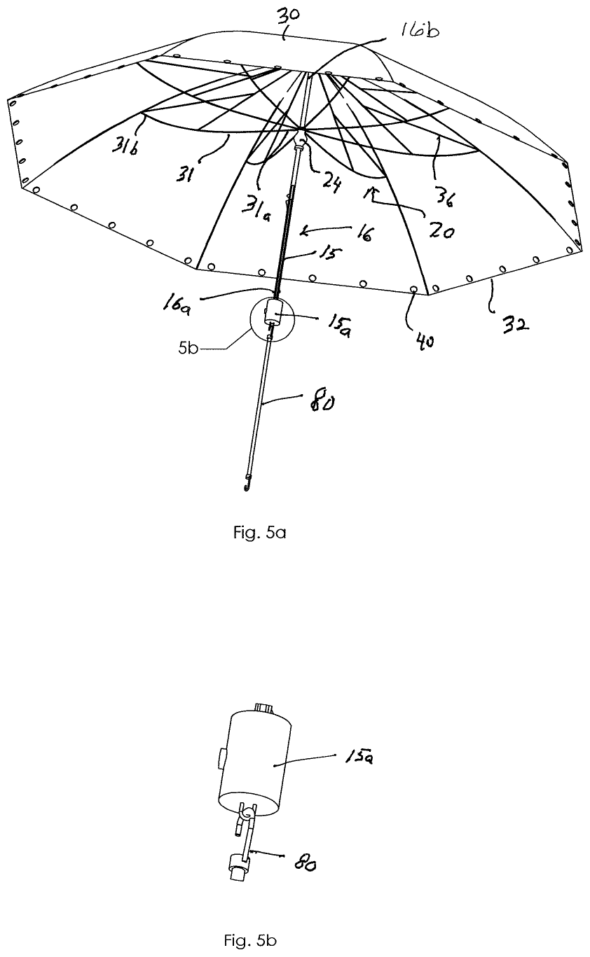

### DESCRIPTION OF THE PREFERRED EMBODIMENT

An umbrella and privacy shield according to a preferred embodiment of the present invention will now be described with reference to the accompanying illustrations. The umbrella and privacy shield 10 may include an umbrella canopy 30 coupled to a linkage 20 configured to open/close the umbrella canopy 30. More particularly, the linkage 20 is movable between a collapsed configuration and an extended or deployed configuration. The umbrella and privacy shield further includes a plurality of magnets 40 coupled to the linkage 20 or to peripheral edge 32 of the canopy 30 itself such that the umbrella canopy 30 may be temporarily magnetically coupled to a roof or door frame of an automobile 100 so as to provide privacy or shielding from a rain event. The umbrella and privacy shield 10 may also include a privacy curtain 50 configured to hang from the linkage 20 or peripheral edges 32 of the umbrella canopy 30. Still further, the umbrella and privacy shield 10 may include a handle 15 and a bungee cord attachable to a handle of a door of the automobile. The handle 15 may extend downwardly to include a grip member 15a and upwardly to become a structure referred to as an umbrella pole 16.

Operation of the umbrella pole 16, linkage 20, and canopy 30 will now be described in greater detail. As shown and described, the canopy 30 is coupled to the distal end 16b of the umbrella pole 16. The umbrella pole 16 also includes a distal end 16b opposed to and displaced from the proximal end 16a such that the umbrella pole 16 includes a generally linear and elongate configuration. When the umbrella pole 16 is pivotally positioned to a desired angle, it may be secured at the selected position. Specifically, a tilt clamp (not shown) may be positioned between respective ends of the umbrella pole 16 and may be selectively tightened to secure an upper portion and umbrella pole 16 at the selected position.

With further reference to the umbrella canopy 30 and related components, a rib assembly includes a plurality of spaced apart ribs 31 each having a generally linear configuration and mounted along on a bottom surface of the canopy 30. Further, each rib has a proximal end 31a coupled to the hub 24 (described in more detail later) and a distal end 31b opposite the proximal end 31a. As shown, each rib 31 extends away from the pole 16. In use, the hub 24 is slidably coupled to the umbrella pole 16 such that sliding action applied thereto causes actuation thereof. Specifically, the linkage 20 is movable from a folded or storage configuration in which the ribs 31 are folded down parallel to and adjacent the umbrella pole 16 and a deployed configuration in which the ribs are opened to an arched configuration extending away from the umbrella pole 16. The canopy 30 may be a weather resistant and semi-flexible sheet of polyester or other weather resistant plastic. It is also understood that the plurality of magnets 40 may be embedded into the interior surface of the canopy portion 30 or, alternatively, coupled to the peripheral edge 32 of the canopy 30. As will be discussed again later, the magnets 40 are configured to mate with complementary magnets for mega portions coupled to the curtain 50.

Each rib 31 extends substantially between a canopy apex 35 and a canopy perimeter edge 32. Further, a hub 24 is slidably coupled to the umbrella pole 16 and is movable therealong toward or away from the canopy apex 35. Further, a plurality of spokes 36 extend between the hub 24 and respective ribs 31, the spokes being arranged such that the canopy 30 is moved between a deployed configuration when the hub 24 is moved toward the umbrella pole distal end 16b (i.e., toward the canopy apex 35) and a retracted configuration when the hub 24 is moved toward the proximal end 16a of the umbrella pole 16 (i.e., away from the canopy apex 35). Described another way, the umbrella canopy 30 is operatively coupled to the distal end 16b of the umbrella pole 16 and movable to the retracted configuration in which the umbrella canopy 30 is loosely surrounding the umbrella pole 16 and the deployed configuration in which the umbrella canopy 30 extends away from the umbrella pole 16 so as to shield or shade an area under the canopy 30, such as the open door of an automobile.

In a critical aspect, the privacy and weather shield 10 may include an elastic fastener 80 for securing the canopy to a side door of the automobile. This would especially be useful if the weather event includes moderate to severe wind. The elastic fastener 80 may be a bungee cord or similar elastic device. A bungee cord is essentially a nylon rubber band with one or more elastic strands forming a core and may be covered in a woven cotton or polypropylene sheets. In the present invention, the elastic fastener 80 may have a first end that may be coupled to the umbrella pole 16 and a second end releasably coupled to a handle of the side door of the automobile (or, alternatively, to a flange/metal loop on the doorframe of the automobile). In an embodiment, each end of the elastic fasteners may include a hook or the like.

In another critical aspect, the umbrella and privacy shield 10 may include a privacy curtain 50 configured for surrounding a user when in use with an automobile. Specifically, the privacy curtain 50 may have a fabric or textile construction that is flexible and elongate and, in one embodiment, may be rolled up for storage and unfurled when needed for privacy. The curtain 50 may include an upper edge 52 and may include a plurality of magnets 53 or metallic members that are configured for attachment to the plurality of magnets 40 positioned on the underside of the canopy 30 or perimeter 32 thereof. In use, it is understood that the plurality of magnets 53 may also be coupled to the automobile door or rooftop such that the curtain 50 hangs therefrom. Together with the automobile structures, the curtain 50 defines an interior space in which a user may change clothes out of the view of others as well as being protected from weather elements.

In use, the linkage 20 may be opened so that the umbrella canopy 30 is opened and extended and configured to shield a user from a rain event. The handle 15 may include a grip member 15a having a linear or J-shaped configuration that enables the user to move and hold the umbrella canopy 30 over her head, such as while walking from a store to the car. Further, the opened umbrella canopy 30 may be positioned atop a roof of the automobile such that the plurality of magnets 40 positioned on an underside of the linkage 20 are magnetically attracted to the metal automobile surface. With the umbrella canopy 30 being held securely to the automobile roof (adjacent a side edge of the roof and adjacent an open car door) a user will have her hands free to lift and transfer packages of merchandise, her baby, or other articles into the automobile under the shield and cover of the opened umbrella canopy 30. When fully loaded, the linkage 20 may be manually retracted and the umbrella canopy 30 collapsed and then stored inside the vehicle cabin. Or, if a user desires a private area in which to change clothes, the curtain 50 and, more particularly, the magnets 53 may be coupled to the plurality of magnets 40 of the umbrella canopy 30, the curtain 50 hanging from the canopy 30 to the ground so as to define an interior or private area between the curtain and the automobile. In addition, if desired, the elastic fastener 80 may be installed as described above so as to provide additional stability to the canopy 30.

It is understood that while certain forms of this invention have been illustrated and described, it is not limited thereto except insofar as such limitations are included in the following claims and allowable functional equivalents thereof.

1. An umbrella privacy shield for use with an automobile, said umbrella privacy shield, comprising:
a handle having a proximal end and a distal end opposite said proximal end;
a linkage that includes a plurality of ribs each of which has a first end operatively coupled to said handle and a second end extending away and displaced from said first end, said linkage being movable between a collapsed configuration in which said plurality of ribs is generally parallel to and adjacent said handle and a deployed configuration extending away from said handle in an arched configuration;
a canopy portion coupled to said plurality of ribs of said linkage, said canopy portion having an interior surface and an exterior surface;
a plurality of magnets spaced apart and attached to said interior surface of said canopy portion, each magnet being configured to anchor the canopy portion to a metal surface will of the automobile.

2. The umbrella privacy shield as in claim 1, wherein said handle includes a grip member situated at said proximal end that is operative for user manipulation of said handle.

3. The umbrella privacy shield as in claim 2, wherein said grip member has a J-shaped configuration.

4. The umbrella privacy shield as in claim 2, wherein said grip member has a linear configuration.

5. The umbrella privacy shield as in claim 1, wherein said linkage is selectively collapsible.

6. The umbrella privacy shield as in claim 1, further comprising a curtain having an upper edge coupled to a perimeter edge of said canopy portion and that has an elongate and flexible configuration that hangs down from said canopy portion.

7. The umbrella privacy shield as in claim 1, wherein said linkage includes a hub that is (1) coupled to respective first ends of said plurality of ribs, and (2) slidably coupled to said handle, said hub being configured to move said linkage between said collapsed and extended configurations, respectively, when actuated to move along said handle.

8. The umbrella privacy shield as in claim 6, wherein said plurality of magnets are spaced apart and positioned along a peripheral edge of the canopy portion.

9. The umbrella privacy shield as in claim 6, wherein said plurality of magnets are each embedded in said interior surface of said canopy portion.

10. The umbrella privacy shield as in claim 6, wherein the canopy portion is constructed of semi-flexible and weather-resistant material.

11. A method for shielding an area proximate an automobile, comprising:
providing an umbrella privacy shield comprising:
an umbrella pole having a proximal end and a distal end opposite said proximal end;
a linkage that includes a plurality of ribs each having a first end operatively coupled to said umbrella pole and a second end extending away and displaced from said first end, said linkage being movable between a collapsed configuration in which said plurality of ribs is folded adjacent said umbrella pole and a deployed configuration extending away from said umbrella pole in an arched configuration;
a canopy portion coupled to said plurality of ribs of said linkage, said canopy portion having an interior surface and an exterior surface;
a plurality of magnets spaced apart and attached to said interior surface of said canopy portion, each magnet being configured to anchor the canopy portion to a rooftop of the automobile;
moving said linkage to said deployed configuration by manipulating said umbrella pole;
positioning said canopy portion over a rooftop of the automobile; and
allowing said plurality of magnets to contact the rooftop of the automobile so as to anchor said umbrella privacy shield thereto.

12. The method as in claim 11, further comprising collapsing said linkage when said canopy portion is not anchored to the automobile.

13. The method as in claim 11, wherein said linkage includes a hub that is (1) coupled to respective first ends of said plurality of ribs, and is (2) slidably coupled to said umbrella pole, said hub being configured to move said linkage between said collapsed and said extended configurations, respectively, when actuated to move slidably along said umbrella pole.

14. The method as in claim 11, wherein said plurality of magnets are spaced apart and positioned along a peripheral edge of the canopy portion.

15. The method as in claim 11, wherein said plurality of magnets are each embedded in said interior surface of said canopy portion.

16. The method as in claim 11, wherein they canopy portion is constructed of semi-flexible and weather-resistant material.

17. The method as in claim 11, further comprising unfurling a privacy curtain having an upper edge coupled to a perimeter edge of said canopy portion of said umbrella privacy shield.

18. The method as in claim 17, wherein said privacy curtain is constructed of a flexible and opaque material and has an elongate configuration.

19. The method as in claim 17, wherein said privacy curtain includes an upper edge having a plurality of magnets spaced apart from one another and each being configured to selectively mate with said plurality of magnets of said umbrella canopy.

20. The method as in claim 11, further comprising connecting an elastic fastener at a first end to said umbrella pole and at a second end to an open door of the automobile,
